(19) United States
(12) Patent Application Publication
(10) Pub. No.: US 2022/0366240 A1
(43) Pub. Date: Nov. 17, 2022

(54) APPARATUS AND METHOD FOR TASK-ADAPTIVE NEURAL NETWORK RETRIEVAL BASED ON META-CONTRASTIVE LEARNING

(71) Applicants: AITRICS CO., LTD., Seoul (KR); KOREA ADVANCED INSTITUTE OF SCIENCE AND TECHNOLOGY, Daejeon (KR)

(72) Inventors: Sung Ju HWANG, Seongnam-si (KR); Wonyong JEONG, Seoul (KR); Ha Yeon LEE, Incheon (KR); Geon PARK, Seoul (KR); Eun Young HYUNG, Anyang-si (KR)

(73) Assignees: AITRICS CO., LTD., Seoul (KR); KOREA ADVANCED INSTITUTE OF SCIENCE AND TECHNOLOGY, Daejeon (KR)

(21) Appl. No.: 17/731,710

(22) Filed: Apr. 28, 2022

(30) Foreign Application Priority Data
Apr. 29, 2021 (KR) 10-2021-0055996
Apr. 21, 2022 (KR) 10-2022-0049434

(51) Int. Cl. G06N 3/08

(52) U.S. Cl. CPC G06N 3/08

(57) ABSTRACT

Disclosed herein are an apparatus and method for task-adaptive neural network retrieval based on meta-contrastive learning. The apparatus for task-adaptive neural network retrieval based on meta-contrastive learning includes: memory configured to store a database including a learning model pool consisting of a plurality of datasets and neural networks pre-trained on the datasets and also store a program for task-adaptive neural network retrieval based on meta-contrastive learning; and a controller configured to perform task-adaptive neural network retrieval based on meta-contrastive learning by executing the program. In this case, the controller learns a cross-modal latent space for datasets and neural networks trained on the datasets by calculating the similarity between each dataset and a neural network trained on the dataset while considering constraints included in any one task previously selected from the database, thereby retrieving an optimal neural network.

### CROSS-REFERENCE TO RELATED APPLICATION

This application claims the benefit of Korean Patent Application No. 10-2021-0055996 filed on Apr. 29, 2021 and Korean Patent Application No. 10-2022-0049434 filed on Apr. 21, 2022, which is hereby incorporated by reference herein in its entirety.

### BACKGROUND

### 1. Technical Field

The embodiments disclosed herein relate generally to an apparatus and method for task-adaptive neural network retrieval based on meta-contrastive learning, and more particularly to an apparatus and method for task-adaptive neural network retrieval based on meta-contrastive learning that can retrieve not only the architectures of neural networks but also parameters and calculate the similarity between each dataset and a neural network pre-trained on the dataset to learn a cross-modal latent space with contrastive loss, thereby retrieving an optimal neural network.

### 2. Description of the Related Art

Recently, the demand for the introduction of artificial intelligence (AI) technology is increasing not only in information technology (IT) and tech companies but also in the overall industry.

However, there arise problems in that high cost is required to hire an expert who can use AI technology and high investment cost is required for the research and development of AI technology.

To solve these problems, there has been studied Neural Architecture Search (NAS) using techniques such as search via a genetic algorithm, gradient-based optimization search, search through lower network sampling from an upper network, meta search, etc. In this case, NAS is a technology that automatically designs the best neural network model when data is given.

However, although NAS including the above-described techniques can design an optimal neural network architecture for given data, it has a problem in that parameters cannot be generated. Accordingly, to actually use a generated neural network architecture, there arises a problem in that it is necessary to learn a given dataset from the beginning. Furthermore, when a target dataset is changed, there is a problem in that all processes ranging from NAS to parameter generation must be re-executed.

Meanwhile, the above-described background technology corresponds to technical information that has been possessed by the present inventor in order to contrive the present invention or that has been acquired in the process of contriving the present invention, and can not necessarily be regarded as well-known technology that had been known to the public prior to the filing of the present invention.

### RELATED ART LITERATURE

Patent document 1: Korean Patent No. 10-2232138 (published on Mar. 25, 2021)

### SUMMARY

An object of the embodiments disclosed herein is to provide an apparatus and method for task-adaptive neural network retrieval based on meta-contrastive learning that can retrieve not only the architectures of neural networks but also parameters and calculate the similarity between each dataset and a neural network pre-trained on the dataset to learn a cross-modal latent space with contrastive loss, thereby retrieving an optimal neural network.

Other objects and advantages of the present invention may be understood from the following description, and will be more clearly understood by the following embodiments. Furthermore, it will be readily apparent that the objects and advantages of the present invention may be achieved by the means and combinations thereof described in the claims.

As a technical solution for accomplishing the above object, according to an embodiment, there is provided an apparatus for task-adaptive neural network retrieval based on meta-contrastive learning, the apparatus including: memory configured to store a database including a learning model pool consisting of a plurality of datasets and neural networks pre-trained on the datasets and also store a program for task-adaptive neural network retrieval based on meta-contrastive learning; and a controller configured to perform task-adaptive neural network retrieval based on meta-contrastive learning by executing the program; wherein the controller learns a cross-modal latent space for datasets and neural networks trained on the datasets by calculating the similarity between each dataset and a neural network trained on the dataset while considering constraints included in any one task previously selected from the database, thereby retrieving an optimal neural network.

According to another embodiment, there is provided a method for task-adaptive neural network retrieval based on meta-contrastive learning, the method being performed by an apparatus for task-adaptive neural network retrieval based on meta-contrastive learning, the method including: previously selecting any one task from a database including a learning model pool consisting of a plurality of datasets stored in memory and neural networks pre-trained on the datasets; and learning a cross-modal latent space for datasets and neural networks trained on the datasets by calculating the similarity between each dataset and a neural network trained on the dataset while considering constraints included in the any one task previously selected from the database, thereby retrieving an optimum neural network.

According to still another embodiment, there is provided a non-transitory computer-readable storage medium having stored thereon a program that, when executed by a processor, causes the processor to execute a method for task-adaptive neural network retrieval based on meta-contrastive learning, the method being performed by an apparatus for task-adaptive neural network retrieval based on meta-contrastive learning, the method including: previously selecting any one task from a database including a learning model pool consisting of a plurality of datasets stored in memory and neural networks pre-trained on the datasets; and learning a cross-modal latent space for datasets and neural networks trained on the datasets by calculating the similarity between each dataset and a neural network trained on the dataset while considering constraints included in the any one task previously selected from the database, thereby retrieving an optimum neural network.

According to still another embodiment, there is provided a computer program that is executed by an apparatus for task-adaptive neural network retrieval based on meta-contrastive learning and stored in a non-transitory computer-readable storage medium in order to perform a method for task-adaptive neural network retrieval based on meta-contrastive learning, the method being performed by an apparatus for task-adaptive neural network retrieval based on meta-contrastive learning, the method including: previously selecting any one task from a database including a learning model pool consisting of a plurality of datasets stored in memory and neural networks pre-trained on the datasets; and learning a cross-modal latent space for datasets and neural networks trained on the datasets by calculating the similarity between each dataset and a neural network trained on the dataset while considering constraints included in the any one task previously selected from the database, thereby retrieving an optimum neural network.

### BRIEF DESCRIPTION OF THE DRAWINGS

Hereinafter, the accompanying drawings illustrate embodiments disclosed herein, and serve to allow the technical spirit disclosed herein to be fully understood together with specific details for carrying out the invention, so that the contents disclosed herein should not be construed as being limited only to those described in the drawings.

FIG. 1 is a functional block diagram of an apparatus for task-adaptive neural network retrieval based on meta-contrastive learning according to an embodiment;

FIGS. 2 to 3 are exemplary diagrams illustrating an apparatus for task-adaptive neural network retrieval based on meta-contrastive learning according to an embodiment; and

FIG. 4 is a flowchart of a method for task-adaptive neural network retrieval based on meta-contrastive learning according to an embodiment.

### DETAILED DESCRIPTION

Various embodiments will be described in detail below with reference to the accompanying drawings. The following embodiments may be modified to various different forms and then practiced. In order to more clearly illustrate features of the embodiments, detailed descriptions of items that are well known to those having ordinary skill in the art to which the following embodiments pertain will be omitted. Furthermore, in the drawings, portions unrelated to descriptions of the embodiments will be omitted. Throughout the specification, like reference symbols will be assigned to like portions.

Throughout the specification, when one component is described as being “connected” to another component, this includes not only a case where the one component is “directly connected” to the other component but also a case where the one component is “connected to the other component with a third component arranged therebetween.” Furthermore, when one portion is described as “including” one component, this does not mean that the portion does not exclude another component but means that the portion may further include another component, unless explicitly described to the contrary.

Embodiments of the present invention will be described in detail below with reference to the accompanying drawings.

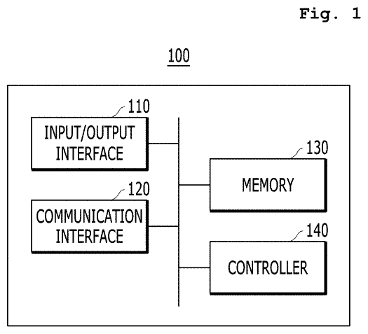

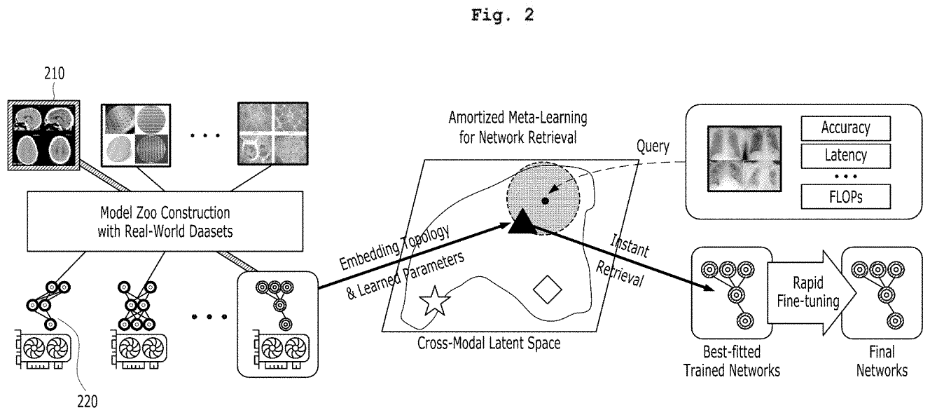

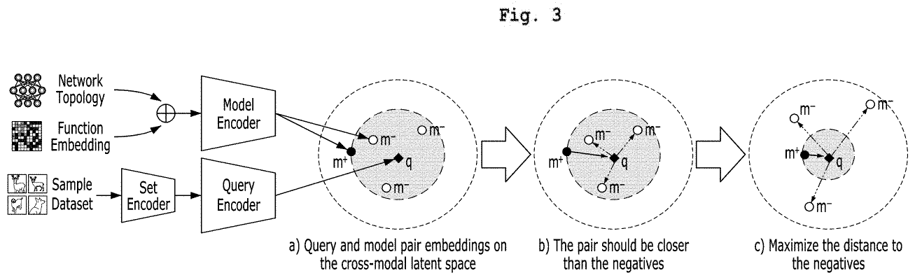

FIG. 1 is a functional block diagram of an apparatus for task-adaptive neural network retrieval based on meta-contrastive learning according to an embodiment, and FIGS. 2 to 3 are exemplary diagrams illustrating an apparatus for task-adaptive neural network retrieval based on meta-contrastive learning according to an embodiment.

An apparatus 100 for task-adaptive neural network retrieval based on meta-contrastive learning according to an embodiment may be implemented as an electronic terminal on which an application capable of interacting with a user is installed, may be implemented as a server, or may be implemented as a server-client system. When the apparatus 100 for task-adaptive neural network retrieval based on meta-contrastive learning is implemented as a server-client system, it may include an electronic terminal on which an online service application for interaction with a user is installed.

In this case, the electronic terminal may be implemented as a computer, a mobile terminal, a television, a wearable device, or the like that can connect to a remote server over a network or connect with another terminal and a server. In this case, the computer includes, e.g., a notebook, a desktop, a laptop, and the like that are each equipped with a web browser. The mobile terminal is, e.g., a wireless communication device capable of guaranteeing portability and mobility, and may include all types of handheld wireless communication devices, such as a Personal Communication System (PCS) terminal, a Personal Digital Cellular (PDC) terminal, a Personal Handyphone System (PHS) terminal, a Personal Digital Assistant (PDA), a Global System for Mobile communications (GSM) terminal, an International Mobile Telecommunication (IMT)-2000 terminal, a Code Division Multiple Access (CDMA)-2000 terminal, a W-Code Division Multiple Access (W-CDMA) terminal, a Wireless Broadband (Wibro) Internet terminal, a smartphone, a Mobile Worldwide Interoperability for Microwave Access (mobile WiMAX) terminal, and the like. Furthermore, the television may include an Internet Protocol Television (IPTV), an Internet Television (Internet TV), a terrestrial TV, a cable TV, and the like. Moreover, the wearable device is an information processing device of a type that can be directly worn on a human body, such as a watch, glasses, an accessory, clothing, shoes, or the like, and can access a remote server or be connected to another terminal over a network directly or via another information processing device.

In addition, the server may be implemented as a computer capable of communicating over a network with an electronic terminal on which an application for interaction with a user of the apparatus 100 for task-adaptive neural network retrieval based on meta-contrastive learning or a web browser is installed, or may be implemented as a cloud computing server. Furthermore, the server may include a storage device capable of storing data, or may store data through a third server.

As described above, the apparatus 100 for task-adaptive neural network retrieval based on meta-contrastive learning may be implemented in the form of any one of an electronic terminal and a server-client system. When the apparatus 100 for task-adaptive neural network retrieval based on meta-contrastive learning is implemented as a server-client system, components constituting the apparatus 100 for task-adaptive neural network retrieval based on meta-contrastive learning may be implemented in a plurality of physically separated servers, or may be implemented in a single server.

Referring to FIG. 1, the apparatus 100 for task-adaptive neural network retrieval based on meta-contrastive learning according to the present embodiment includes an input/output interface 110, a communication interface 120, memory 130, and a controller 140.

The input/output interface 110 may include an input interface configured to receive input from a user, and an output interface configured to display information such as the results of the performance of a task, the status of the apparatus 100 for task-adaptive neural network retrieval based on meta-contrastive learning, etc. For example, the input/output interface 110 may include an operation panel configured to receive user input, and a display panel configured to display screens.

More specifically, the input interface may include devices capable of receiving various types of user input, such as a keyboard, physical buttons, a touch screen, a camera, a microphone, etc. Furthermore, the output interface may include a display panel, a speaker, etc. However, the input/output interface 110 is not limited thereto, but may include components capable of supporting various types of input and output.

The communication interface 120 may perform wired/wireless communication with another terminal or a network. To this end, the communication interface 120 may include a communication module that supports at least one of various wired/wireless communication methods. For example, the communication module may be implemented in the form of a chipset.

Meanwhile, the wireless communication supported by the communication interface 120 may be wireless mobile communication such as Wireless Fidelity (Wi-Fi), Wi-Fi Direct, Bluetooth, Bluetooth Low Energy (BLE), Ultra-Wide Band (UWB), Near Field Communication (NFC), LTE, LTE-Advanced, or the like. In addition, the wired communication supported by the communication unit 120 may be, e.g., Universal Serial Bus (USB) or High Definition Multimedia Interface (HDMI).

The memory 130 may allow various types of data, such as files, applications and programs, to be installed and stored, and may be configured to include at least one of various types of memory such as random access memory (RAM), a hard disk drive (HDD), and a solid-state drive (SSD). The controller 140 to be described later may access and use data stored in the memory 130, or may store new data in the memory 130. Furthermore, the controller 140 may execute a program installed on the memory 130. Meanwhile, in the memory 130, a database including a learning model pool consisting of a plurality of datasets and neural networks pre-trained on the datasets may be stored, and a program for performing a method for task-adaptive neural network retrieval based on meta-contrastive learning according to an embodiment may be installed.

The controller 140 has a configuration including at least one processor such as a central processing unit (CPU), a graphics processing unit (GPU), an Arduino, or the like, and may control the overall operation of the apparatus 100 for task-adaptive neural network retrieval based on meta-contrastive learning. In other words, the controller 140 may control other components included in the apparatus 100 for task-adaptive neural network retrieval based on meta-contrastive learning. Furthermore, the controller 140 may execute a program stored in the memory 130, may read a file stored in the memory 130, or may store a new file in the memory 130.

According to an embodiment, the controller 140 may perform task-adaptive neural network retrieval based on meta-contrastive learning. For example, as shown in FIG. 2, the controller 140 may retrieve a neural network most suitable for a designated dataset in a task-adaptive manner by searching a database including a model zoo, which is a learning model pool consisting of various datasets 210 and a large number of neural networks 220 pre-trained on the datasets. In this case, the controller 140 may learn a learning model through the amortized meta-learning of a cross-modal latent space. In other words, the controller 140 constructs a cross-modal latent space by outputting an embedding topology indicative of the architectures of networks and learned parameters in neural networks trained on datasets from the database including the model zoo, which is the learning model pool consisting of the datasets 210 and the large number of neural networks 220 pre-trained on the datasets. In this case, when constructing the cross-modal latent space, the controller 140 may learn the cross-modal latent space by calculating the similarity between the datasets and the neural networks having learning the datasets while considering constraints including accuracy, latency, operation speed (floating point operations per second (FLOPS)), etc. In this case, since the controller 140 has retrieved not only the architectures of neural networks but also parameters, it may retrieve the best-fitted trained networks through the instant retrieval of the trained networks without additional cost, and may finally find a final network through rapid fine tuning. Meanwhile, more detailed information related thereto will be described later. In connection with this, information for the retrieval of a task-adaptive neural network based on meta-contrastive learning by the controller 140 may be required, and such information may be stored in the memory 130.

The controller 140 learns a cross-modal latent space for datasets and neural networks trained on the datasets by calculating the similarity between each dataset and a neural network trained on the dataset while considering the constraints included in any one task previously selected from the database, thereby retrieving an optimal neural network. In this case, the optimal neural network may refer to a neural network that can most satisfy the given task and the constraints among the trained neural networks included in the database.

According to an embodiment, the controller 140 may learn a cross-modal latent space for each pair of a dataset and a neural network trained on the dataset, and may then retrieve an optimal neural network for a dataset and constraints. In this case, the retrieved neural network may include a topology and parameters.

Meanwhile, task-adaptive neural network retrieval using amortized meta-contrastive learning will be described as follows:

Meta-Training

There is a database including a learning model pool consisting of neural networks pre-trained on a distribution of tasks p(τ) along with each task τ={D^{τ},N^{τ},s^{τ}}. In this equation, D^{τ} denotes a dataset, N^{τ} denotes a neural network trained on the dataset, and s^{τ} denotes a set of pieces of corresponding information for a given task, which consists of the number of parameters for the neural network, accuracy for the dataset, and computational latency. In other words, s^{rτ} may be constraints. Thereafter, it may be possible to learn the cross-modal latent space for pairs (D^{τ},N^{τ}) of datasets and neural networks trained on the datasets while considering the constraints s^{τ} over the distribution of tasks p(τ). In this manner, a meta-trained model may retrieve a well-fitted neural network for an unseen dataset with the constraints s^{τ} from diverse pairs (D^{τ},N^{τ}) and rapidly generalize on the unseen dataset \hat{D}; D^{τ}∩\hat{D}=ϕ.

Task-Adaptive Neural Network Retrieval

The goal of task-adaptive retrieval is to find the appropriate network N^{τ} for the given query dataset D^{τ} for the given task τ. To this end, it is necessary to calculate the similarity between the dataset-neural network pair (D^{τ},N^{τ})∈ [symbol] × [symbol] , and a scoring function ƒ may output the similarity between them as follows:

max_{θ,ϕ}Σ_{τ∈p(τ)}ƒ(q,m)

q=Q(D^{τ};θ) and m=M(N^{τ};ϕ)

Q: [symbol] → [symbol] ^{d} (1)

where Q: [symbol] → [symbol] ^{d} is a query encoder, M: [symbol] → [symbol] ^{d} is a model encoder, and ƒ: [symbol] ^{d}× [symbol] ^{d}→ [symbol] is a scoring function for a query-model pair. In this manner, the controller 140 may construct the cross-modal latent space for dataset-network pairs over the distribution of tasks by using Equation 1, and may then use this space to rapidly retrieve the well-fitted neural network in response to the unseen query dataset. In this case, there may be the query encoder Q and the model encoder M. In order to perform rapid retrieval by achieving the above-mentioned purpose, the cross-modal latent space for pairs of datasets and neural networks trained on the datasets may be learned.

Retrieval with Meta-Contrastive Learning

The meta-contrastive learning for each task τ∈p(τ) consisting of a dataset-model pair (D^{τ},N^{τ}) ∈ [symbol] × [symbol] aims to maximize the similarity between positive pairs: ƒ(q,m⁺) while minimizing the similarity between negative pairs: ƒ(q,m⁻). In this case, m⁺ may be obtained from the sampled target task τ∈p(τ) and m⁻ may be obtained from other tasks γ∈p(τ); γ≠τ. This meta-contrastive learning loss may be represented by Equation 2 below:

[symbol]

ₘ(τ;θ,ϕ)= [symbol] (ƒ(q,m⁺),ƒ(q,m⁻);θ,ϕ)

q=Q(D^{τ};θ),m⁺=M(N^{τ};ϕ),m⁻=M(N^{γ};ϕ) (2)

Meanwhile, the contrastive loss for the meta-contrastive learning may be represented by Equation 3 below:

$$max ( 0 , α - log \frac{exp ( f ( q , {m}^{+} ) )}{exp ( {\sum }_{γ ∈ p ( τ ) ; γ \neq τ} f ( q , {m}^{-} )} ) \qquad ( 3 )$$

where α∈ [symbol] is a margin hyper-parameter, and the score function ƒ is the cosine similarity. The contrastive loss promotes the positive (q,m⁺) embedding pair to be close together, with at most margin α closer than the negative (q,m⁻) embedding pairs in the learned cross-modal metric space.

Similarly, the query may be contrasted with [symbol] _{q}(ƒ(q⁺,m),ƒ(q⁻,m)). With the above ingredients, the meta-contrastive learning loss over the distribution of tasks p(τ), defined with a model contrastive loss [symbol] ₘ and a query contrastive loss [symbol] _{q}, may be minimized as in Equation 4 below:

max_{ϕ,θ}Σ_{τ∈p(τ)} [symbol] ₘ(τ;θ,ϕ)+ [symbol] _{q}(τ;θ,ϕ) (4)

Meanwhile, an example of the meta-contrastive learning for cross-modal retrieval is as shown in FIG. 3. Referring to FIG. 3, a model encoder, a set encoder, and a query encoder may be used for the meta-contrastive learning.

In this case, the model encoder may be an encoder configured to receive neural networks trained on datasets and output a model embedding, and the neural networks learned on the input datasets may consist of topology information indicative of the architectures of the networks and a functional embedding indicative of the learning knowledge (parameters) of the networks. Meanwhile, the topology information may refer to once-for-all (OFA) topology information indicative of a kernel size, channel extension information, and the depth of layers. Furthermore, the functional embedding may utilize an output, obtained through an unbiased random noise input generated by Gaussian random noise, as an embedding that reflects the learning knowledge (parameters) of a model. The model encoder may be designed as a multi-layer perceptron.

According to an embodiment, a model encoder considers both a model parameter and an architecture learned from each dataset D^{τ} for each task τ in order to encode a neural network N^{τ}. The model encoder may generate a model embedding using a network topology and a functional embedding. Referring to the paper (Cai, H., Gan, C., Wang, T., Zhang, Z., and Han, S. Once for all: Train one network and specialize it for efficient deployment. In International Conference on Learning Representations, 2020.), the model encoder according to the present embodiment may first obtain a topological embedding vₜ^{τ} including auxiliary information about an architecture topology such as the numbers of layers, channel extension ratios, and kernel sizes. Thereafter, the parameters of the neural network architecture may be further considered by encoding the model parameters learned for a given task. In this case, since it is considerably difficulty and inefficient to directly encode millions of parameters into a vector, a functional embedding operation may be used to solve this problem. Meanwhile, this operation may generate the embedding of trained neural networks by feeding fixed Gaussian random noise to each neural network N^{τ} and obtaining an output v_{ƒ}^{τ} thereof. The intuition behind the functional embedding is straightforward because networks with different architectures and parameters include different functions so that they may produce different outputs for the same input. With the two encoding functions described above, the model encoder may generate a model representation by concatenating the network topology and the functional embedding [vₜ^{τ}, v_{ƒ}^{τ}] and then transforming the concatenated vector with a nonlinear function g denoted as follows: m^{τ}=g([vₜ^{τ},v_{ƒ}^{τ}])=M(N^{τ};ϕ). In this equation, m^{τ} is a model embedding, and ϕ is a learnable parameter for the model encoder.

The set encoder may receive each dataset as an input, may generate a query dataset, and may output the query dataset to the query encoder.

The query encoder may be an encoder that receives a query dataset and outputs a query embedding. The query encoder may be an average pooling-based set encoder that is designed as a multi-layer perceptron.

According to an embodiment, the query encoder Q(D;θ): [symbol] → [symbol] ^{d} may embed a dataset D as a single query vector q onto the cross-modal latent space. Since each dataset D consists of n data instances D={Xᵢ}ᵢ₌₁ⁿ ∈ [symbol] , it is desirable to fulfill a permutation-invariance condition over the data instances Xᵢ to output a consistent representation regardless of the order of its instances. To achieve this, the present embodiment first individually transforms n randomly sampled instances for the dataset D with a continuous learnable function ρ, and then applies a pooling operation to obtain the query vector q=Σ_{X}_{ᵢ}_{∈D}ρ(Xᵢ) based on the paper (Zaheer, M., Kottur, S., Ravanbakhsh, S., Poczos, B., Salakhutdinov, R. R., and Smola, A. J. Deep sets. In Advances in Neural Information Processing Systems (NIPS), 2017).

Meta-Performance Surrogate Model

A performance surrogate model S(τ;ψ) may be meta-trained over the distribution of tasks p(τ) in the database including the learning model pool consisting of the plurality of datasets and the neural networks pre-trained on the datasets. In this case, ψ is a learnable parameter of the meta-performance surrogate model. This meta-performance surrogate model not only accurately predicts the performance on the unseen dataset beforehand, but also guides the cross-modal retrieval space to be discriminative on the performance for dataset-network pairs, which leads to the selection of the high-performing neural networks among candidates for the given dataset. More specifically, the meta-performance surrogate model S may take a query embedding q^{τ} and a model embedding m^{τ} as input for the given task τ, and may then forward them to predict the accuracy of the model for the query. The performance predictor S(τ;ψ) may be trained to minimize the mean-square error loss [symbol] ₛ(τ;ψ)=(s_{acc}^{τ}−S(τ;ψ))² between the predicted accuracy S(τ;ψ) and the true accuracy s_{acc}^{τ} for the model on each task τ, which is sampled from the distribution of tasks p(τ). Thereafter, learning may proceed according to Equation 5 below, which is shown in combination with Equation 4 above:

max_{ϕ,θ,ψ}Σ_{τ∈p(τ)} [symbol] ₘ(τ;θ,ϕ)+ [symbol] _{q}(τ;θ,ϕ)+λ· [symbol] ₛ(τ;ψ) (5)

where λ is a hyper-parameter for weighting losses.

According to an embodiment, the controller 140 may instantly retrieve the best-fitted neural network N∈ [symbol] with its parameters in response to the unseen query dataset \hat{D}∈ [symbol] , which is disjoint from the meta-training dataset D∈ [symbol] , by leveraging the meta-learned cross-modal latent space.

Amortized Inference

The conventional NAS methods require at least GPU hours for training to retrieve architectures for an unseen dataset \hat{D}. Compared to these methods, an apparatus for task-adaptive neural network retrieval based on meta-contrastive learning according to an embodiment only needs a single forward pass per dataset to obtain a query embedding \hat{q} for the unseen dataset using the query encoder (Q(\hat{D};θ*) with meta-trained parameters θ* because a model is trained with amortized meta-learning over a distribution of tasks p(τ). After obtaining the query embedding, the best-fitted network N for the query is retrieved based on the similarity (see Equation 6 below):

N=max_{N}_{^{τ}}{ƒ(\hat{q},m^{τ})|τ∈p(τ)} (6)

where a set of model embeddings {m^{τ}|τ∈p(τ)} is previously calculated by a meta-trained model encoder M(N^{τ};ϕ*).

Performance Prediction

According to an embodiment, one of the best performances among top K candidate neural networks {\hat{N}ᵢ}ᵢ₌₁^{K} may be selected based on the performance predicted using a meta-learned performance predictor S. Since the performance predictor including a module that considers datasets is meta-learned over the distribution of tasks p(τ), the performance for the unseen dataset D may be predicted without training.

Task-Adaptive Initialization

According to an embodiment, given an unseen dataset, a neural network, which is trained on a particular training dataset that is highly similar to the unseen query dataset, may be retrieved (see FIG. 3). Therefore, the fine-tuning time of the trained network for the unseen target dataset \hat{D} is effectively reduced because the retrieved neural network N has task-relevant initial parameters that are already trained on a similar dataset contained in the database including a learning model pool consisting of a plurality of datasets and neural networks pre-trained on the datasets. If it is necessary to further consider constraints S such as parameters and FLOPS, then whether retrieved models meet the specific constraints for the task may be easily checked by sorting them in the descending order of their scores and then selecting the constraint-fitted best accuracy model.

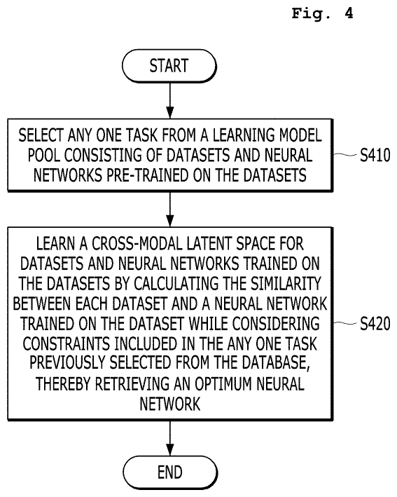

FIG. 4 is a flowchart of a method for task-adaptive neural network retrieval based on meta-contrastive learning according to an embodiment.

The method for task-adaptive neural network retrieval based on meta-contrastive learning according to the embodiment, which is shown in FIG. 4, includes steps that are processed in a time-series manner by the apparatus 100 for task-adaptive neural network retrieval based on meta-contrastive learning, which is shown in FIGS. 1 to 3. Accordingly, the descriptions that are omitted below but have been given above in conjunction with the apparatus 100 shown in FIGS. 1 to 3 may also be applied to the method shown in FIG. 4.

As shown in FIG. 4, in step S410, the apparatus 100 for task-adaptive neural network retrieval based on meta-contrastive learning according to the present embodiment previously selects any one task from a database including a learning model pool consisting of a plurality of datasets stored in memory and neural networks pre-trained on the datasets.

In step S420, the apparatus 100 for task-adaptive neural network retrieval based on meta-contrastive learning learns a cross-modal latent space for datasets and neural networks trained on the datasets by calculating the similarity between each dataset and a neural network trained on the dataset while considering constraints included in the any one task previously selected from the database, thereby retrieving an optimum neural network.

The term “unit” used in the above-described embodiments means software or a hardware component such as a field-programmable gate array (FPGA) or application-specific integrated circuit (ASIC), and a “unit” performs a specific role. However, a “unit” is not limited to software or hardware. A “unit” may be configured to be present in an addressable storage medium, and also may be configured to run one or more processors. Accordingly, as an example, a “unit” includes components, such as software components, object-oriented software components, class components and task components, processes, functions, attributes, procedures, subroutines, segments in program code, drivers, firmware, microcode, circuits, data, a database, data structures, tables, arrays, and variables.

Components and a function provided in “unit(s)” may be coupled to a smaller number of components and “unit(s)” or divided into a larger number of components and “unit(s).”

In addition, components and “unit(s)” may be implemented to run one or more central processing units (CPUs) in a device or secure multimedia card.

The method for task-adaptive neural network retrieval based on meta-contrastive learning according to the embodiment descried herein may be implemented in the form of a computer-readable medium that stores instructions and data that can be executed by a computer. In this case, the instructions and the data may be stored in the form of program code, and may generate a predetermined program module and perform a predetermined operation when executed by a processor. Furthermore, the computer-readable medium may be any type of available medium that can be accessed by a computer, and may include volatile, non-volatile, separable and non-separable media. Furthermore, the computer-readable medium may be a computer storage medium. The computer storage medium may include all volatile, non-volatile, separable and non-separable media that store information, such as computer-readable instructions, a data structure, a program module, or other data, and that are implemented using any method or technology. For example, the computer storage medium may be a magnetic storage medium such as an HDD, an SSD, or the like, an optical storage medium such as a CD, a DVD, a Blu-ray disk or the like, or memory included in a server that can be accessed over a network.

Furthermore, the method for task-adaptive neural network retrieval based on meta-contrastive learning according to the embodiment descried herein may be implemented as a computer program (or a computer program product) including computer-executable instructions. The computer program includes programmable machine instructions that are processed by a processor, and may be implemented as a high-level programming language, an object-oriented programming language, an assembly language, a machine language, or the like. Furthermore, the computer program may be stored in a tangible computer-readable storage medium (for example, memory, a hard disk, a magnetic/optical medium, a solid-state drive (SSD), or the like).

Accordingly, the method for task-adaptive neural network retrieval based on meta-contrastive learning according to the embodiment descried herein may be implemented in such a manner that the above-described computer program is executed by a computing apparatus. The computing apparatus may include at least some of a processor, memory, a storage device, a high-speed interface connected to memory and a high-speed expansion port, and a low-speed interface connected to a low-speed bus and a storage device. These individual components are connected using various buses, and may be mounted on a common motherboard or using another appropriate method.

In this case, the processor may process instructions within a computing apparatus. An example of the instructions is instructions which are stored in memory or a storage device in order to display graphic information for providing a Graphic User Interface (GUI) onto an external input/output device, such as a display connected to a high-speed interface. As another embodiment, a plurality of processors and/or a plurality of buses may be appropriately used along with a plurality of pieces of memory. Furthermore, the processor may be implemented as a chipset composed of chips including a plurality of independent analog and/or digital processors.

Furthermore, the memory stores information within the computing device. As an example, the memory may include a volatile memory unit or a set of the volatile memory units. As another example, the memory may include a non-volatile memory unit or a set of the non-volatile memory units. Furthermore, the memory may be another type of computer-readable medium, such as a magnetic or optical disk.

In addition, the storage device may provide a large storage space to the computing device. The storage device may be a computer-readable medium, or may be a configuration including such a computer-readable medium. For example, the storage device may also include devices within a storage area network (SAN) or other elements, and may be a floppy disk device, a hard disk device, an optical disk device, a tape device, flash memory, or a similar semiconductor memory device or array.

The above-described embodiments are intended for illustrative purposes. It will be understood that those having ordinary knowledge in the art to which the present invention pertains can easily make modifications and variations without changing the technical spirit and essential features of the present invention. Therefore, the above-described embodiments are illustrative and are not limitative in all aspects. For example, each component described as being in a single form may be practiced in a distributed form. In the same manner, components described as being in a distributed form may be practiced in an integrated form.

The scope of protection pursued through the present specification should be defined by the attached claims, rather than the detailed description. All modifications and variations which can be derived from the meanings, scopes and equivalents of the claims should be construed as falling within the scope of the present invention.

According to any one of the above-described solutions, there may be expected the effect of retrieving not only the architectures of neural networks but also parameters and calculating the similarity between each dataset and a neural network pre-trained on the dataset to learn a cross-modal latent space with contrastive loss, thereby rapidly retrieving an optimal neural network and also reducing the overhead generated in the process.

The effects that can be obtained by the embodiments disclosed herein are not limited to the effects described above, and other effects not described above will be clearly understood by those having ordinary skill in the art, to which the present invention pertains, from the foregoing description.

What is claimed is:

1. An apparatus for task-adaptive neural network retrieval based on meta-contrastive learning, the apparatus comprising:
memory configured to store a database including a learning model pool consisting of a plurality of datasets and neural networks pre-trained on the datasets and also store a program for task-adaptive neural network retrieval based on meta-contrastive learning; and
a controller configured to perform task-adaptive neural network retrieval based on meta-contrastive learning by executing the program;
wherein the controller learns a cross-modal latent space for datasets and neural networks trained on the datasets by calculating a similarity between each dataset and a neural network trained on the dataset while considering constraints included in any one task previously selected from the database, thereby retrieving an optimal neural network.

2. The apparatus of claim 1, wherein the controller constructs the cross-modal latent space for the datasets and the neural networks trained on the datasets for a distribution of tasks by using Equation 1 below:
max_{θ,ϕ}Σ_{τ∈p(τ)ƒ(}q, m)
q=Q(D^{τ};θ) and m=N(N^{τ};ϕ)
Q: [symbol] → [symbol] ^{d}
where Q: [symbol] → [symbol] ^{d} is a query encoder, M: [symbol] → [symbol] ^{d} is a model encoder, and ƒ: [symbol] ^{d}× [symbol] ^{d}→ [symbol] is a scoring function for a query-model pair.

3. The apparatus of claim 2, wherein the controller retrieves a neural network by learning the cross-modal latent space using amortized meta-learning that maximizes a similarity between a positive embedding pair of a neural network for the any one task previously selected and minimizes a similarity between a negative embedding pair thereof.

4. The apparatus of claim 3, wherein the controller calculates a similarity between each dataset and a neural networks trained on the dataset by calculating a meta-contrastive learning loss using Equation 2 below: [symbol]
ₘ(τ;θ,ϕ)= [symbol] (ƒ(q,m⁺), ƒ(q,m⁻); θ,ϕ)
q=Q(D^{τ};θ),m⁺=M(N^{τ};ϕ),m⁻=M(N^{γ};ϕ) (2)

5. A method for task-adaptive neural network retrieval based on meta-contrastive learning, the method being performed by an apparatus for task-adaptive neural network retrieval based on meta-contrastive learning, the method comprising:
previously selecting any one task from a database including a learning model pool consisting of a plurality of datasets stored in memory and neural networks pre-trained on the datasets; and
learning a cross-modal latent space for datasets and neural networks trained on the datasets by calculating a similarity between each dataset and a neural network trained on the dataset while considering constraints included in the any one task previously selected from the database, thereby retrieving an optimum neural network.

6. The method of claim 5, wherein retrieving the optimum neural network comprises constructing the cross-modal latent space for the datasets and the neural networks trained on the datasets for a distribution of tasks by using Equation 1 below:
max_{θ,ϕ}Σ_{τ∈p(τ)}ƒ(q,m)
q=Q(D^{τ};θ) and m=M(N^{τ};ϕ)
Q: [symbol] → [symbol] ^{d}
where Q: [symbol] → [symbol] ^{d} is a query encoder, M: [symbol] →|^{d} is a model encoder, and ƒ: [symbol] ³× [symbol] ^{d}→ [symbol] is a scoring function for a query-model pair.

7. The method of claim 6, wherein retrieving the optimum neural network comprises learning the cross-modal latent space by using amortized meta-learning that maximizes a similarity between a positive embedding pair of a neural network for the any one task previously selected and minimizes a similarity between a negative embedding pair thereof.

8. The method of claim 7, wherein retrieving the optimum neural network comprises calculating a similarity between each dataset and a neural network trained on the dataset by calculating a meta-contrastive learning loss using Equation 2 below: [symbol]
ₘ(τ;θ,ϕ)= [symbol] (ƒ(q,m⁺),ƒ(q,m⁻);θ,ϕ)
q=Q(D^{τ};θ),m⁺=M(N^{τ};ϕ),m⁻=M(N^{γ};ϕ) (2)

9. A non-transitory computer-readable storage medium having stored thereon a program that, when executed by a processor, causes the processor to execute the method of claim 5.

10. A computer program that is executed by an apparatus for task-adaptive neural network retrieval based on meta-contrastive learning and stored in a non-transitory computer-readable storage medium in order to perform the method of claim 5.
